(19) United States
(12) Patent Application Publication
(10) Pub. No.: US 2010/0216011 A1
(43) Pub. Date: Aug. 26, 2010

(54) BATTERY PACK

(75) Inventors: Daehyung YOO, Suwon-si (KR); Jintae HONG, Suwon-si (KR)

Correspondence Address: STEIN MCEWEN, LLP, 1400 EYE STREET, NW, SUITE 300, WASHINGTON, DC, 20005, US

(73) Assignee: Samsung SDI Co., Ltd., Suwon-si (KR)

(21) Appl. No.: 12/712,243

(22) Filed: Feb. 25, 2010

(30) Foreign Application Priority Data
Feb. 26, 2009 (KR) 10-2009-0016316

(51) Int. Cl. H01M 2/24

(52) U.S. Cl. 429/160

(57) ABSTRACT

A battery pack that includes a plurality of bare cells including a first bare cell and a second bare cell, and a lead plate electrically connecting the first bare cell and the second bare cell. A bent area of the lead plate may be provided with a hole or a groove.

### CROSS-REFERENCE TO RELATED APPLICATIONS

This application claims the benefit of Korean Application No. 10-2009-0016316, filed Feb. 26, 2009 in the Korean Intellectual Property Office, the disclosure of which is incorporated herein by reference.

### BACKGROUND OF THE INVENTION

1. Field of the Invention

Aspects of the present invention relate to a battery pack.

2. Description of the Related Art

Secondary batteries may be manufactured and used in an individual battery (that is, in a bare cell) according to types of apparatuses using the secondary batteries. However, the secondary batteries may be manufactured and used in a battery pack formed of a plurality of individual batteries. When the plurality of bare cells is manufactured as a battery pack, the bare cells are electrically connected to each other via a lead plate.

The lead plate is generally formed from a thin flat plate. When one bare cell is connected to another bare cell, the lead plate is bent such as to be connected with a side of each of the two bare cells. Therefore, the lead plate needs to be smoothly bent (bent more easily than a conventional lead plate without the hole or the groove) such that no damage occurs in a bent portion thereof.

### SUMMARY OF THE INVENTION

Aspects of the present invention provide a battery pack having a lead plate that can be smoothly bent and does not become damaged by vibration.

According to an aspect of the present invention, there is provided a battery pack including: a plurality of bare cells including a first bare cell and a second bare cell; and a lead plate electrically connecting the first bare cell and the second bare cell, wherein a hole is formed in a bent area of the lead plate.

The hole may be located at a middle of a width between a first length side and a second length side of the lead plate and/or may be located at a middle of a length between a first width side and a second width side of the lead plate.

The hole may have a substantially circular shape, and/or the hole may have a diameter of about 0.2 mm to about 1 mm.

According to another aspect of the present invention, there is provided a battery pack including: a plurality of bare cells including a first bare cell and a second bare cell; and a lead plate electrically connecting the first bare cell and the second bare cell, wherein a groove is formed in a bent area of the lead plate.

The groove may be formed in a straight line shape parallel to a width direction between a first length side and a second length side of the lead plate.

The groove may include a plurality of sub grooves arranged parallel to a width direction between a first length side and a second length side of the lead plate, and each of the plurality of sub grooves may be formed to have a substantially circular shape.

The groove may be located at a middle of a width between a first length side and a second length side of the lead plate, and may be located at a middle of a length between a first width side and a second width side of the lead plate.

The groove may have a depth less than about 5/100 mm, and may have a length with a ratio to a width between a first length side and a second length side of the lead plate of 1:3 to 1:2.

A first side of the groove, closest to a first length side of the lead plate, and a second side of the groove, closest to a second length side of the lead plate, may be spaced apart from the first length side and the second length side of the lead plate, respectively.

According to yet another aspect of the present invention, there is provided a lead plate of a battery pack including a first bare cell and a second bare cell, the lead plate including: a bent area with a hole formed therein to allow the lead plate to be smoothly bent and to prevent the lead plate from breaking by a vibration thereof, wherein the lead plate connects the first bare cell and the second bare cell.

According to still another aspect of the present invention, there is provided a lead plate of a battery pack including a first bare cell and a second bare cell, the lead plate including: a bent area with a groove formed therein to allow the lead plate to be smoothly bent and to prevent the lead plate from breaking by a vibration thereof, wherein the lead plate connects the first bare cell and the second bare cell.

According to another aspect of the present invention, there is provided a method of connecting a first bare cell to a second bare cell in a battery pack, the method including: forming a hole or a groove in a middle area of a lead plate; bending the lead plate at the middle area thereof; connecting the first bare cell to a first side of the bent lead plate, and the second bare cell to a second side, opposite the first side, of the bent lead plate.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a perspective view illustrating a battery pack according to an embodiment of the present invention;

FIG. 2 is an enlarged perspective view illustrating a portion of FIG. 1 indicated by square A;

FIG. 3 is a plan view illustrating a lead plate of a battery pack according to an embodiment of the present invention;

FIG. 4 is a perspective view illustrating a lead plate of a battery pack according to an embodiment of the present invention;

FIG. 5 is a plan view illustrating a lead plate of a battery pack according to another embodiment of the present invention;

FIG. 6 is a sectional view illustrating a lead plate of a battery pack according to another embodiment of the present invention; and

FIG. 7 is a plan view illustrating a lead plate of a battery pack according to another embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

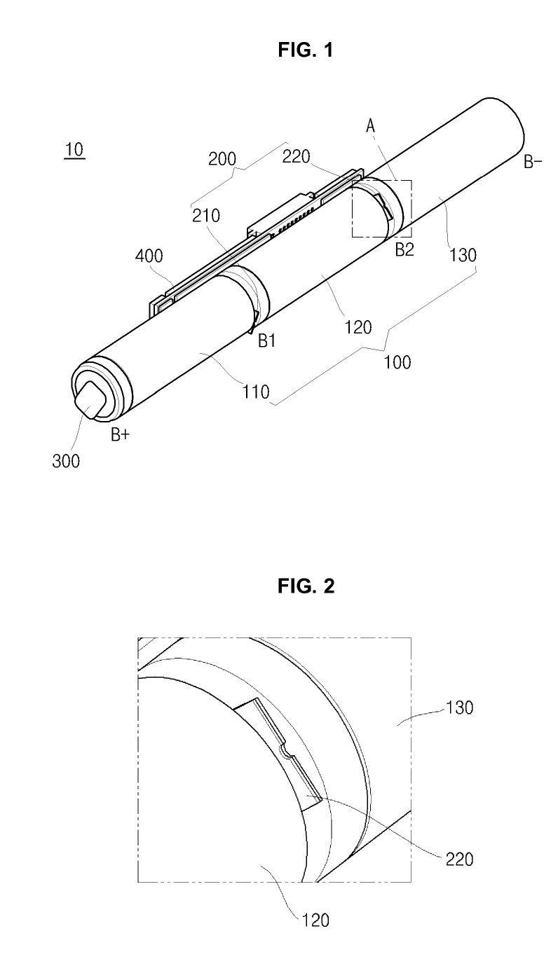

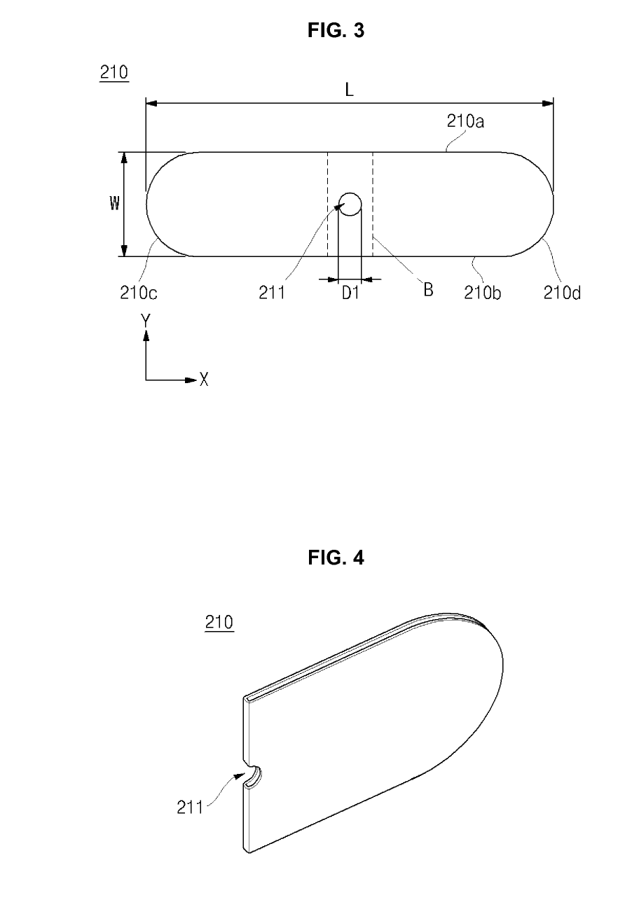

Hereinafter, a battery pack 10 according to embodiments of the present invention will be described in detail with reference to the accompanying drawings. FIG. 1 is a perspective view illustrating a battery pack 10 according to an embodiment of the present invention. FIG. 2 is an enlarged perspective view illustrating a portion of FIG. 1 indicated by square A. FIG. 3 is a plan view illustrating a lead plate 210 of the battery pack 10 according to an embodiment of the present invention. FIG. 4 is a perspective view illustrating the lead plate 210 of the battery pack 10 according to an embodiment of the present invention. Referring to FIGS. 1 to 4, the battery pack 10 includes a plurality of bare cells 100, the lead plate 200, a terminal plate 300, and a protective circuit module 400.

Each of the plurality of bare cells 100 may include an electrode assembly (not illustrated), a can accommodating the electrode assembly, and a cap assembly coupled at an opening of the can accommodating the electrode assembly. FIG. 1 illustrates a first bare cell 110, a second bare cell 120, and a third bare cell 130 that are connected in series, though it is understood that aspects of the present invention are not limited to this number and connection of the bare cells 100. For example, the battery pack 10 may include two or more bare cells 100, and the bare cells 100 can be connected in parallel and/or in series.

In FIG. 1, B+ and B− are signs for a high current end, and represent electrodes of opposite ends of the bare cells 100 connected in series. Specifically, B+ represents the highest electric potential end as a positive electrode, and B− represents the lowest electric potential end as a negative electrode. Therefore, a positive electrode terminal of the first bare cell 110 may be the highest electric potential end, and a negative electrode terminal of the third bare cell 130 may be the lowest electric potential end.

The bare cells 100 may be connected in series by the lead plate 200 including a first lead plate 210 provided at a B1 electric potential end between the first bare cell 110 and the second bare cell 120, and a second lead plate 220 provided at a B2 electric potential end between the second bare cell 120 and the third bare cell 130. The lead plate 200 and bare cells 100 may be coupled to each other by welding. The lead plate 200 may be bent at a middle portion thereof and may be formed in a substantially flattened C shape. Furthermore, the lead plate 200 may be made of a metal having high electric conductibility, such as copper, nickel, aluminum, etc. The lead plate 200 may be directly electrically connected with the protective circuit module 400, though it is understood that aspects of the present invention are not limited thereto. For example, according to other aspects, the lead plate 200 may be electrically connected with the protective circuit module 200 via a cover lay film on which conductive metal patterns are formed. The structure of the lead plate 200 will be described in detail later.

A terminal plate 300 may be located on the positive terminal of the first bare cell 110 and the negative terminal of the third bare cell 130 (not shown). The terminal plate 300 may be formed of a metal having high electric conductibility, such as copper, nickel, aluminum, etc. Moreover, the terminal plate 300 may be directly electrically connected with the protective circuit module 400, though it is understood that aspects of the present invention are not limited thereto. For example, according to other aspects, the terminal plate 300 may be electrically connected with the protective circuit module 400 via the cover lay film on which conductive metal patterns are formed.

The protective circuit module 400 may be provided at a side of the bare cells 100, and may be electrically connected to the lead plates 200 and the terminal plates 300. The protective circuit module 400 may include protective circuit devices and connectors. Furthermore, the protective circuit module 400 may check a charge-discharge state, a current, a voltage, and a temperature of the bare cells 100 to protect the battery pack 10.

Hereinafter, the lead plate 200 will be explained in detail. In the embodiment illustrated in FIG. 1, the lead plate 200 includes the first lead plate 210 provided at the B1 electric potential end between the first bare cell 110 and the second bare cell 120, and the second lead plate 220 provided at the B2 electric potential end between the second bare cell 120 and the third bare cell 130. Hereinafter, the first lead plate 210 between the first bare cell 110 and the second bare cell 120 will be explained. However, the second lead plate 220 between the second bare cell 120 and the third bare cell 130 has the same or similar structure and/or operation as the first lead plate 210.

The lead plate 210 may be formed in a flat plate of which the length L is larger than the width W thereof. The length sides of the lead plate 210 include a first length side 210a and a second length side 210b. Two width sides of the lead plate 210 are referred to as a first width side 210c and a second width side 210d, respectively. The first and second width sides 210c and 210d may be formed in a curve as illustrated in FIG. 3, though it is understood that aspects of the present invention are not limited thereto. For example, according to other aspects, the first and second width sides 210c and 210d may be formed in a straight line.

Furthermore, the lead plate 210 may be bent at a middle portion thereof to connect the first bare cell 110 and the second bare cell 120. Here, the bent middle portion of the lead plate 210 is referred to as a bent area B. As illustrated, a hole 211 is formed in the bent area B to pass through the lead plate 210. The hole 211 may be formed to have a substantially circular shape, though aspects of the present invention are not limited thereto.

The hole 211 may be formed at a middle of the bent area B. Therefore, the hole 211 may be located at a middle of the width W between the first length side 210a and the second length side 210b of the lead plate 210, and may be located at a middle of the length L between the first width side 210c and the second width side 210d of the lead plate 210. Furthermore, the hole 211 may be formed in the bent area B of the lead plate 210, and allows the lead plate 210 to be smoothly bent when the lead plate 210 is bent to electrically connect the first bare cell 110 and the second bare cell 120.

The hole 211 formed in the lead plate 210 may have a diameter D1 of about 0.2 mm to about 1 mm, though aspects of the present invention are not limited thereto. That is, in the current embodiment, when the diameter D1 of the hole 211 is smaller than 0.2 mm, the lead plate 210 may not be bent smoothly. Moreover, when the diameter D1 of the hole 211 is larger than 1 mm, the lead plate 210 may be cracked from a portion in which the hole 211 is formed during a bending process. Although while the lead plate 210 is being bent, no crack may be generated, when the lead plate 210 is vibrated by the rocking of the battery pack 10 later, the lead plate 210 may be cracked from the portion in which the hole 211 is formed, and may eventually break. Therefore, the size of the hole 211 formed in the bent area B of the lead plate 210 is accurately controlled corresponding to the size of the lead plate 210. According to the current embodiment, when the hole 211 has the size between 0.2 mm and 1 mm, the hole 211 may allow the lead plate 210 to be smoothly bent, and may prevent the lead plate 210 from being broken by vibration of the lead plate 210. Furthermore, to smoothly bend the lead plate 210 and to protect the lead plate 210 from being broken by a vibration thereof, the lead plate 210 may be provided with only one hole 211 having the size of the above-described numerical range in the bent area B thereof.

There may be some differences in composition between the lead plate 210 according to other embodiments of the present invention and the lead plate 210 according to an embodiment of the present invention as described with reference to FIGS. 1 through 4. Therefore, differences in composition as compared to the above-described lead plate 210 will be mainly explained for purposes of clarity and brevity.

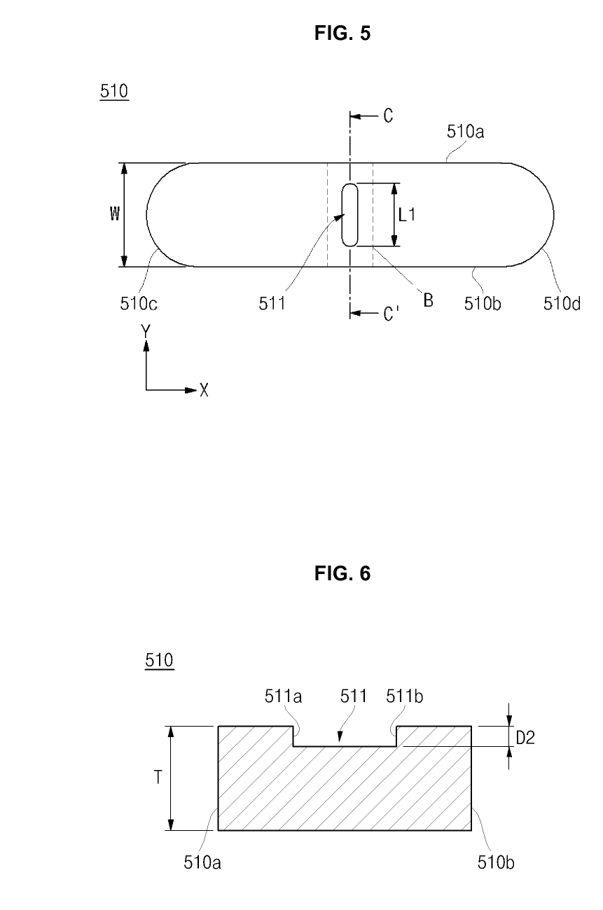

FIGS. 5 and 6 are a plan view and sectional view illustrating a lead plate 510 of a battery pack 10 according to another embodiment of the present invention. FIG. 6 is a sectional view illustrating the lead plate 510 taken along a line C-C in FIG. 5. Referring to FIGS. 5 and 6, the lead plate 510 includes a groove 511 formed in a bent area B. The groove 511 has a bottom surface and is formed in a straight line shape. That is, the groove is formed in an elongated groove parallel to the width direction Y of the lead plate 510. Furthermore, the groove 511 may be formed in a middle of the bent area B. That is, the groove 511 may be located at a middle of the width W between the first and second length sides 510a and 510b of the lead plate 510, and may be located at a middle of the length between the first and second width sides 510c and 510d of the lead plate 510.

The groove 511 is formed in the bent area B of the lead plate 510, and allows the lead plate 510 to be smoothly bent when the lead plate 510 is bent to electrically connect the first bare cell and the second bare cell. At this time, to prevent a portion in which the groove 511 is formed from being broken, the lead plate 510 may be bent so that a surface of the lead plate 510 on which the groove 511 is formed becomes an inner side of the lead plate 510 after being bent.

The groove 511 may have a depth D2 less than about 5/100 mm, though it is understood that aspects of the present invention are not limited thereto. That is, in the current embodiment, when the depth D2 of the groove 511 is 5/100 mm and over, the lead plate 510 may be cracked from the portion in which the groove 511 is formed during a bending process. Although while the lead plate 510 is being bent, no crack is generated, when the lead plate 510 is vibrated by the rocking of the battery pack later, the lead plate 510 may be cracked from the portion in which the groove 511 is formed, and may eventually break. Accordingly, the depth D2 is determined to allow the lead plate 510 to be smoothly bent, and to prevent the lead plate 510 from being broken by vibration of the lead plate 510.

Also, the groove 511 may have a length L1 with a ratio to the width W between the first and second length sides 510a and 510b of the lead plate 510 of 1:3 to 1:2, though it is understood that aspects of the present invention are not limited thereto. That is, in the current embodiment, when the length L1 of the groove 511 is shorter than ⅓ of the width W of the lead plate 510, the lead plate 510 may not be bent smoothly. When the length L1 of the groove 511 is longer than ½ of the width W of the lead plate 510, the lead plate 510 may be cracked from the portion in which the groove 511 is formed during a bending process. Although while the lead plate 510 is being bent, no crack is generated, when the lead plate 510 is vibrated by the rocking of the battery pack later, the lead plate 510 may be cracked from the portion in which the groove 511 is formed, and may eventually break. Accordingly, the length L1 is determined to allow the lead plate 510 to be smoothly bent, and to prevent the lead plate 510 from being broken by vibration of the lead plate 510.

Furthermore, a first side 511a and a second side 511b of the groove 511 corresponding to each of the first length side 510a and the second length side 510b of the lead plate 510 may be spaced apart from the first length side 510a and the length long side 510b, respectively to prevent the groove 511 from breaking during a bending process.

Therefore, the depth, length, and/or position of the groove 511 formed in the bent area B of the lead plate 510 are accurately controlled according to the size of the lead plate 510. When the groove 511 has a size corresponding to the numerical ranges described above, the groove 511 may allow the lead plate 510 to be smoothly bent, and may prevent the lead plate 510 from being broken by vibration of the lead plate 510. Furthermore, to smoothly bend the lead plate 510 and protect the lead plate 510 from being broken by vibration thereof, the lead plate 510 may be provided with only one groove having a size corresponding to the numerical ranges described above in the bent area B thereof.

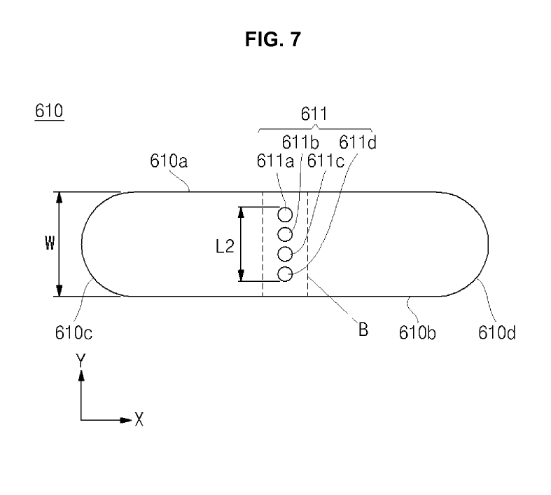

Hereinafter, a lead plate according to another embodiment of the present invention will be explained. FIG. 7 is a plan view illustrating a lead plate 610 of a battery pack according to another embodiment of the present invention. Referring to FIG. 7, the lead plate 610 is provided with a groove 611 formed in a plurality of sub grooves 611a, 611b, 611c, and 611d parallel to the width direction Y of the bent area B thereof. The plurality of sub grooves 611a, 611b, 611c, and 611d may be arranged in a straight line parallel to the width direction Y of the lead plate 610. In FIG. 7, the groove 611 has four sub grooves 611a, 611b, 611c, and 611d, though aspects of the present invention are not limited thereto. That is, the groove 611 may have any number of sub grooves corresponding to the thickness and width W of the lead plate 610. Each of the sub grooves 611a, 611b, 611c, and 611d may have a substantially circular shape.

If the groove 611 having the plurality of sub grooves 611a, 611b, 611c, and 611d is thought of as one groove, the groove 611 may be formed in a middle of the bent area B of the lead plate 610. Therefore, the groove 611 may be located at a middle of the width W between a first length side 610a and a second length side 610b of the lead plate 610, and may be located at a middle of the length between a first width side 610c and a second width side 610d of the lead plate 610. Furthermore, the groove 611 may be formed in the bent area B of the lead plate 610, and allows the lead plate 610 to be smoothly bent when the lead plate 610 is bent to electrically connect the first bare cell and the second bare cell. At this time, to prevent the bent area B in which the groove 611 is formed from being broken, the lead plate 610 may be bent so that a surface of the lead plate 610 on which the groove 611 is formed becomes an inner side of the lead plate 610 after being bent.

The groove 611 may have a depth less than 5/100 of the thickness of the lead plate 610, though it is understood that aspects of the present invention are not limited thereto. That is, in the current embodiment, when the depth of the groove 611 is greater than or equal to 5/100 of the thickness of the lead plate 610, the lead plate 610 may be cracked from a portion in which the groove 611 is formed during a bending process. Although while the lead plate 610 is being bent, no crack is generated, when the lead plate 610 is vibrated by the rocking of the battery pack later, the lead plate 610 may be cracked from the portion in which the groove 611 is formed, and may eventually break. Accordingly, the depth is determined to allow the lead plate 610 to be smoothly bent, and to prevent the lead plate 610 from being broken by vibration of the lead plate 610.

Also, if the groove 611 formed in the plurality of sub grooves 611a, 611b, 611c, and 611d is thought of as one groove, the groove 611 may have a length L2 with a ratio to the width W between the first and second long sides 610a and 610b of the lead plate of 1:3 to 1:2, though it is understood that aspects of the present invention are not limited thereto. That is, in the current embodiment, when the length L2 of the groove 611 is shorter than ⅓ of the width W of the lead plate 610, the lead plate 610 may not be bent smoothly. Moreover, when the length L2 of the groove 611 is longer than ½ of the width W of the lead plate 610, the lead plate 610 may be cracked from a portion in which the groove 611 is formed during a bending process. Although while the lead plate 610 is being bent, no crack is generated, when the lead plate 611 is vibrated by the rocking of the battery pack later, the lead plate 610 may be cracked from the portion in which the groove 611 is formed, and may eventually break. Accordingly, the length L2 is determined to allow the lead plate 610 to be smoothly bent, and to prevent the lead plate 610 from being broken by vibration of the lead plate 610

The first and second sub grooves 611a and 611d of the groove 611 corresponding to each of the first and second length sides 610a and 610b of the lead plate 610 may be spaced apart from the first length side 610a and the second length side 610b, respectively to prevent the first and second sub grooves 611a and 611d from breaking during a bending process.

The depth, length, position, and number of the groove 611 formed in the bent area B of the lead plate 610 are accurately controlled according to the size of the lead plate 610. When the groove 611 including the plurality of sub grooves 611a, 611b, 611c, and 611d has a size corresponding to the numerical ranges as described above, the groove 611 may allow the lead plate 610 to be smoothly bent, and may prevent the lead plate 610 from being broken by vibration of the lead plate 610. Furthermore, to smoothly bend the lead plate 610 and protect the lead plate 610 from being broken by vibration thereof, the lead plate 610 may be provided with only one groove 611 having a size corresponding to the numerical ranges described above in the bent area B thereof.

A battery pack according to aspects of the present invention is provided with a lead plate having a hole or at least one groove formed in a bent area thereof to smoothly bend the lead plate, and to prevent the lead plate from being broken by vibration. As a result, the battery pack according to aspects of the present invention has an improved reliability.

Although the first lead plate 210 connecting the first bare cell 110 and the second bare cell 120 has been explained above, it is understood that the second lead plate 220 connecting the second bare cell 120 and the third bare cell 130 may have the same or similar features as those of the first lead plate 210. Furthermore, FIG. 1 shows three bare cells 110, 120, 130 and two lead plates 210, 220 located therebetween. However, it is understood that aspects of the present invention are not limited thereto. That is, aspects of the present invention may be applied to various battery packs having at least two bare cells. In this case, the first bare cell can be any of the at least two bare cells, and the second bare cell can be any other bare cell that is nearest to the first bare cell and is connected to the first bare cell in series.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A battery pack comprising:
a plurality of bare cells comprising a first bare cell and a second bare cell; and
a lead plate electrically connecting the first bare cell and the second bare cell;
wherein a hole is provided in a bending area of the lead plate, the hole being formed in the area prior to the lead plate being bent.

2. The battery pack as claimed in claim 1, wherein the hole has a substantially circular shape.

3. The battery pack as claimed in claim 1, wherein the hole is located at, or substantially at, a middle of a width between a first length side and a second length side of the lead plate.

4. The battery pack as claimed in claim 1, wherein the hole is located at, or substantially at, a middle of a length between a first width side and a second width side of the lead plate.

5. The battery pack as claimed in claim 1, wherein the hole has a diameter of approximately 0.2 mm to 1 mm.

6. The battery pack as claimed in claim 1, wherein the lead plate connects the first bare cell and the second bare cell in series.

7. The battery pack as claimed in claim 1, wherein the bending area is located at a middle portion of the lead plate, such that the lead plate is folded at the bending area and substantially flattened.

8. The battery pack as claimed in claim 1, wherein the hole allows the lead plate to be smoothly bent and prevents the lead plate from breaking by a vibration thereof.

9. A battery pack comprising:
a plurality of bare cells comprising a first bare cell and a second bare cell; and
a lead plate electrically connecting the first bare cell and the second bare cell;
wherein a groove is provided in a bending area of the lead plate, the groove being formed in the area prior to the lead plate being bent.

10. The battery pack as claimed in claim 9, wherein the groove is formed in a straight line shape parallel to a width direction between a first length side and a second length side of the lead plate.

11. The battery pack as claimed in claim 9, wherein the groove comprises a plurality of sub grooves arranged in a line parallel to a width direction between a first length side and a second length side of the lead plate.

12. The battery pack as claimed in claim 11, wherein each of the plurality of sub grooves is formed to have a substantially circular shape.

13. The battery pack as claimed in claim 9, wherein the groove is located at, or substantially at, a middle of a width between a first length side and a second length side of the lead plate.

14. The battery pack as claimed in claim 9, wherein the groove is located at, or substantially at, a middle of a length between a first width side and a second width side of the lead plate.

15. The battery pack as claimed in claim 9, wherein a depth of the groove is less than about 5/100 mm.

16. The battery pack as claimed in claim 9, wherein the groove has a length with a ratio to a width between a first length side and a second length side of the lead plate of approximately between 1:3 to 1:2.

17. The battery pack as claimed in claim 9, wherein a first side of the groove, closest to a first length side of the lead plate, and a second side of the groove, closest to a second length side of the plate, are spaced apart from the first length side and the second length side of the lead plate, respectively.

18. The battery pack as claimed in claim 11, wherein a first sub groove, closest to the first length side among the plurality of sub grooves, and a second sub groove, closest to the second length side among the plurality of sub grooves, are spaced apart from the first length side and the second length side of the lead plate, respectively.

19. The battery pack as claimed in claim 9, wherein the bending area is located at a middle portion of the lead plate, such that the lead plate is folded at the bending area and substantially flattened.

20. The battery pack as claimed in claim 9, wherein the groove allows the lead plate to be smoothly bent and prevents the lead plate from breaking by a vibration thereof.
